(19) United States
(12) Patent Application Publication
(10) Pub. No.: US 2015/0217628 A1
(43) Pub. Date: Aug. 6, 2015

(54) WINDOW-MOUNTED MOTOR VEHICLE VENTILATION SYSTEM

(71) Applicant: David Joseph Talarico, Holmdel, NJ (US)

(72) Inventor: David Joseph Talarico, Holmdel, NJ (US)

(21) Appl. No.: 14/606,955

(22) Filed: Jan. 27, 2015

Related U.S. Application Data
(60) Provisional application No. 61/934,175, filed on Jan. 31, 2014.
(60) Provisional application No. 62/086,754, filed on Dec. 3, 2014.

(51) Int. Cl. B60H 1/26; B60H 1/24; B60H 1/00

(52) U.S. Cl. CPC B60H 1/265; B60H 1/00735; B60H 1/241

(57) ABSTRACT

A window-mounted motor vehicle ventilation system has a duct, a fan, and a battery that allows for hot air in a parked car to be ventilated to the car's surroundings. In some embodiments, a thermostat allows the user to charge the device less frequently and a removable USB battery pack allows the user to charge the device using most smartphone chargers.

### CROSS-REFERENCE TO RELATED APPLICATIONS

This application claims the benefit of provisional patent application Ser. No. 61/934,175, filed 2014 Jan. 31 by the present inventor. This application also claims the benefit of provisional patent application Ser. No. 62/086,754, filed 2014 Dec. 3 by the present inventor.

### BACKGROUND

### Prior Art

The following is a tabulation of some prior art that presently appears relevant:

### U.S. Patents

| Patent Number | Kind Code | Issue Date | Patentee |
|---|---|---|---|
| 6,224,479 | B1 | 2001 May 1 | Iino |

### U.S. Patent Application Publication

| Publication Nr. | Kind Code | Publ. Date | Applicant |
|---|---|---|---|
| 0,151,761 | A1 | 2011 Jun. 23 | Lesle et al. |

### Foreign Patent Document

| Foreign Doc. Nr. | Cntry Code | Kind Code | Publ. Date | Applicant |
|---|---|---|---|---|
| 203472456 U | CN | B2 | 2014 Mar. 12 | Wang Jun |

The interior of a sealed motor vehicle sitting out in the sun on a hot day can become unbearably hot. Heat is trapped due to the greenhouse effect, and if the windows of the motor vehicle are cracked open or left closed, little to no draft can allow for the hot air to escape. Getting into a hot motor vehicle is a very unpleasant experience, but leaving a window open more than a crack can make your motor vehicle an easy target for theft.

Solar powered window mounted motor vehicle ventilation systems are devices which allow the user to close the window onto the device at a narrow point of the casing to allow the window to stay open a small amount when in use. One device, advertised as “Auto Fan” or “Auto Cool” uses a small solar panel to convert sunlight into electricity, which powers a small fan which is supposed to expel hot air from the motor vehicle. In my experience, this device does not create even close to enough air flow to cool the motor vehicle interior sufficiently. Furthermore, if the device is in the shade, it does not function at all, yet even when in the shade the interior of a motor vehicle may still become very hot.

One solar powered window mounted motor vehicle ventilation system, called the Kulcar, is more effective, but it still suffers from the shading problem. The device is considerably more expensive as well, because solar panels which are large enough to generate sufficient electricity to generate the air flow necessary to cool the inside of a motor vehicle on a hot day are quite expensive. Furthermore, in order to position the panels in direct sunlight, the Kulcar has its solar panel mounted outside of the motor vehicle in a very visible manner, in a way that welcomes theft and vandalism.

There has been a recent rise in the adoption of smartphone technology, and due to their high power consumption, the need for devices which can charge smartphones has increased as well. There is now a large market for accessories that allow a smartphone user to charge their device on the go. Furthermore, an increasing number of smartphone manufacturers have made it possible for the users of their products to charge their devices by connecting it to the Universal Serial Bus (USB) port of a computer, a USB wall outlet adapter, a USB-compatible external battery power source, a USB motor vehicle outlet adapter, etc.

One type of device commonly used for charging smartphones on the go is a USB-compatible external battery power source. This device comprises a rechargeable battery power source and a USB port, which allows the user to charge their smartphone on the go. The recent rise in the demand for this type of device has increased both the number of competing manufacturers as well as the number of these devices which are produced. Hence, market competition and economies of scale have recently driven the price of USB external batteries down considerably.

My invention takes advantage of the nearly universal adoption of USB type connectors by smartphone manufacturers and the new low cost of USB external batteries to provide a more effective alternative to solar powered window-mounted motor vehicle ventilation systems. By using a battery power source, the fan can generate sufficient airflow to reduce the temperature inside the motor vehicle substantially. Furthermore, my invention does not require a solar panel, which will allow for the device to be made at a lower cost and with less complexity.

An apparatus described in a recently published Chinese patent (No. 203472456 U), includes a cartridge installed in a window frame, an intake fan, an exhaust fan, a timer, and a battery. Two fans is unnecessary for the design as almost all vehicles are designed with natural intake vents which will permit cool air to flow into the vehicle when the hot air is pulled out. Furthermore, a timer is unnecessary for the device to function, and requires the user to set the timer and manually activate the device. Also, in conditions with temporary cloud cover and/or temporary shading, the device would remain on even though the car would not be very hot, wasting precious battery life.

My invention takes advantage of a thermostat, which turns on the battery only when it is needed, without any user intervention, thereby making the device more energy efficient and easier to use.

### SUMMARY

In accordance with one embodiment a window-mounted motor vehicle ventilation system exchanges air between a vehicle interior and its surroundings.

### Advantages

Accordingly, advantages of one or more aspects are as follows: to provide a simpler car ventilation system, to provide a less expensive car ventilation system, to provide a more energy efficient car ventilation system, and to provide a car ventilation system that is easier to use. Other advantages of one or more aspects will be apparent from a consideration of the drawings and ensuing description.

### BRIEF DESCRIPTION OF THE DRAWINGS

FIG. 1 is a perspective view of a window mounted motor vehicle ventilation system.

FIG. 2 is an enlarged view of a window mounted motor vehicle ventilation system.

FIG. 3 is a sectional view of a window mounted motor vehicle ventilation system.

FIG. 4 is a perspective view of a window mounted motor vehicle ventilation system.

FIG. 5 is an enlarged view of a window mounted motor vehicle ventilation system.

FIG. 6 is a top view of a window mounted motor vehicle ventilation system.

FIG. 7 is a sectional view of a window mounted motor vehicle ventilation system.

### DETAILED DESCRIPTION

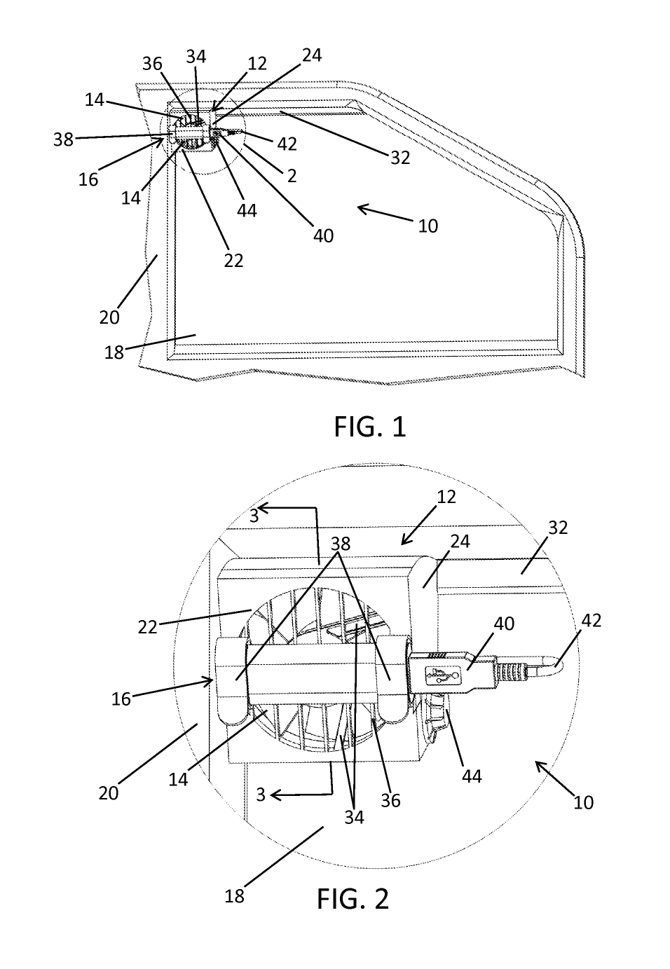

### FIG. 1-3

### First Embodiment

In one embodiment, shown in FIG. 1-3, a window mounted motor vehicle ventilation system, generally designated 10, comprises an air duct 12, an electric fan 14, and an electric power source 16. Power source 16 energizes fan 14 to push hot air out of the motor vehicle through duct 12. A motor vehicle window 18 and a motor vehicle door 20 are shown for reference purposes.

### FIG. 1-3—Description of a Duct

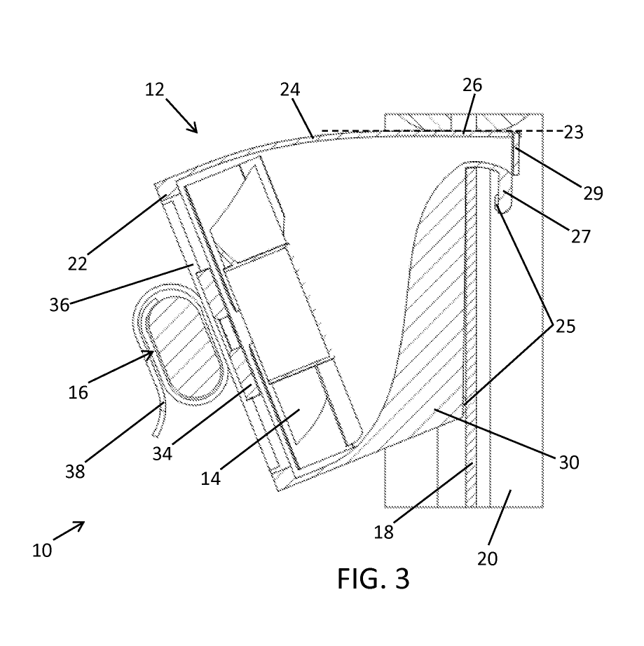

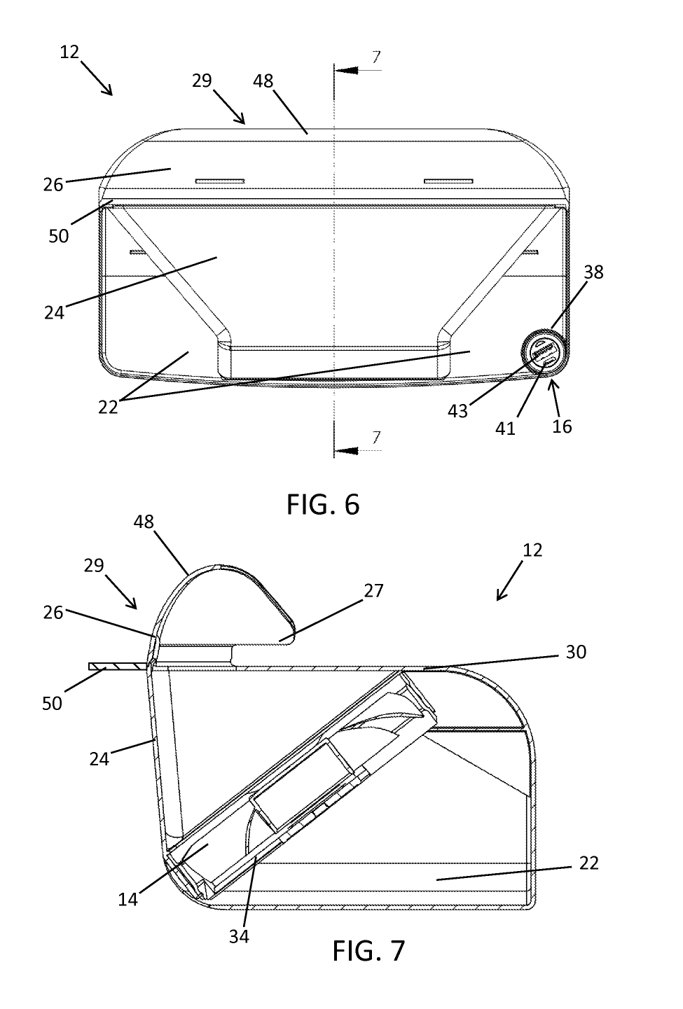

Duct 12 comprises an inlet portion 22, a middle portion 24, and an outlet portion 26 (outlet portion 26 is shown in FIG. 3, FIG. 6, and FIG. 7). In one embodiment, duct 12 is made of one or more segments (not shown) to facilitate its manufacture. To install ventilation system 10, the user closes window 18 onto outlet portion 26 of duct 12 such that inlet 22 remains inside the motor vehicle. One skilled in the art will appreciate that duct 12 should be designed to sufficiently maximize the volumetric flow rate of air while sufficiently minimizing the overall size of duct 12. Examples of such duct geometry are shown in FIG. 3 and FIG. 6. It should be noted that duct 12 should remain substantially below horizontal plane 23 (represented by a dashed line in FIG. 3) defined by the upper surface of outlet portion 26 when duct 12 is installed such that it does not interfere with differing motor vehicle geometries. It should also be noted that outlet portion 26 should protrude out of motor vehicle door 20 a suitably small amount when installed, so it does not invite vandalism or interfere with any vent visors, window deflectors, or the like. The cross section of outlet portion 26 taken in the plane of window 18 should be strong enough to withstand the force of an electric-powered motor vehicle window closing onto it.

In one embodiment, middle portion 24 of duct 12 is made entirely of a rigid material, such as injection molded polyethylene, ABS plastic, any molded plastic, aluminum, steel, any metal, etc. In another embodiment, middle portion 24 of duct 12 may be entirely rigid and telescopic in nature. In still another embodiment, middle portion 24 may comprise a collapsible (for storage) metal or plastic skeleton (not shown), which connects inlet 22 to outlet 26, wrapped with a substantially impermeable flexible material (not shown) such as flexible plastic sheeting, flexible rubber sheeting, plastic coated fabric, rubberized fabric, etc.

In some embodiments, duct 12 further comprises a window gripper (not shown) which is fixed to the underside of duct 12 near outlet portion 26. The window gripper may comprise one or more spring loaded clamps, one or more suction cups, one or more rubber grips, one or more toggle clamps, one or more screw clamps, etc., which temporarily grip onto the upper edge of window 18.

In one embodiment, shown most clearly in FIG. 3, duct 12 further comprises a support portion 30 which contacts window 18 a suitable distance from the upper edge such that the weight of duct 12 as well as any attached components may be more easily supported. In one embodiment (not shown), support portion 30 is a frame which is hinged about the bottom of inlet portion 22 to collapse for storage. In one embodiment, shown in FIG. 3 and FIG. 7, duct 12 further comprises an overhang 27 near outlet portion 26 which prevents duct 12 from slipping out of the gap in window 18. In some embodiments, shown in FIG. 3, soft rubber or felt contact pads 25 are fixed to support portion 30 and/or to overhang 27 to prevent damage to window 18 or to any existing window tints, decals, coatings, etc. on window 18. In one embodiment, contact pads 25 are made of a transparent material and/or of a material of relatively low thermal conductivity so that they do not get so hot that they damage any existing window tints, decals, coatings, etc. on window 18. In one embodiment, support portion 30 comprises a large opening (not shown) with a gasket (not shown) secured at the opening's periphery. The opening and the gasket allows duct 12 to use window 18 as one of its walls by creating a substantial seal between duct 12 and window 18. This reduces the material needed for a given design of duct 12, and it facilitates the manufacture of duct 12 if it is to be made using certain manufacturing processes. In one embodiment, the gasket is made of a light colored, transparent, or translucent material so as to prevent the sun from heating the gasket above a temperature that may damage coatings or tints that may exist on window 18. In one embodiment, the gasket is made of a solid or hollow soft material of low thermal conductivity such as silicone rubber, PVC, etc. to reduce the amount heat transferred from duct 12 to tints or coatings which may exist on window 18.

In one embodiment, shown in FIG. 3, duct 12 comprises a rain blocker 29. In one embodiment, rain blocker 29 is a flap which is rotatably mounted at its upper edge to the top of outlet portion 26. Rain blocker flap 29 thusly acts as a one way valve, interfering with overhang 27 to substantially prevent rain or wind from entering into duct 12 from the outside of the motor vehicle, yet opening freely to when air is pushed by fan 14 from inside the motor vehicle. Additionally or alternatively, rain blocker 29 may comprise a rain hood 48 (FIG. 6 and FIG. 7) which protrudes out of the motor vehicle a suitable amount from the top of outlet portion 26 and then down a suitable amount to substantially prevent rain from entering duct 12.

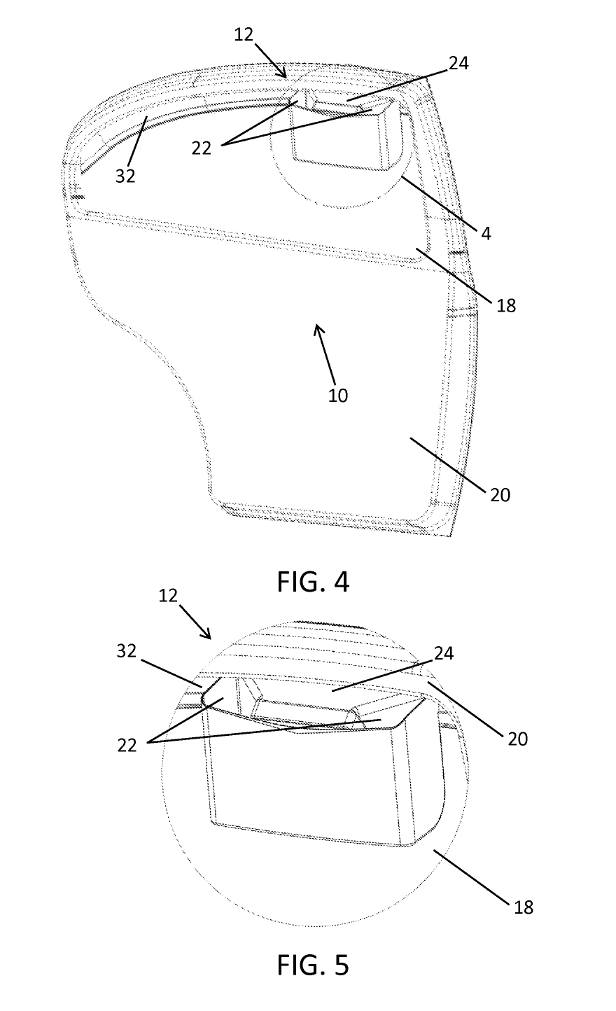

In some embodiments, examples shown in FIG. 1, FIG. 2, FIG. 4 and FIG. 5, weather stripping 32 is installed along the upper edge of window 18 adjacent to duct 12 so as to substantially prevent rainwater from entering the motor vehicle. The user may trim weather stripping 32 to the correct length for use with his or her particular motor vehicle. The mounting position of duct 12 is considered exemplary, as duct 12 may be mounted a suitable distance along the substantially straight upper edge of window 18. This may require two pieces of weather stripping to be cut, one for each side of duct 12.

In one embodiment, duct 12 further comprises a plurality fan supports 34 which extend radially from the walls of inlet 22 of duct 12 to the center of the opening of inlet 22. Fan 14 is thusly attached to fan supports 34 in the usual manner. Fan supports 34 are narrow enough that they do not substantially impede the flow of air generated by fan 14. In one embodiment, the gap between the blades of fan 14 and the surrounding opening of duct 12 is minimized to reduce leakage flows but not so small that the blades' motions are obstructed during normal operation. In one embodiment, shown in FIG. 1-2, inlet 22 further comprises a safety grate 36 to protect the user from incidental contact with the blades of fan 14 during operation. In one embodiment, fan 14 is an axial fan of a suitably large diameter to increase efficiency, but not so big as to create an inconvenient obstruction to a driver and/or a passenger of the vehicle in which system 10 is installed. In one embodiment, fan 14 is positioned adjacent to window 18 at an upward facing angle to substantially reduce pressure loss and to prevent duct 12 from protruding an excessive distance into the vehicle.

### FIG. 1-3—Description of a Power Source

A battery power source describes a device which comprises a battery. It may also comprise an electronic battery power source management system (not shown), which may be capable of charging, discharging, preventing overcharging, preventing over discharging, preventing thermal runaway, preventing overheating, preventing short circuiting, releasing internal battery power source pressure, monitoring the charge state of the battery power source, and even communicating the charge state to the user using any suitable known means (e.g. one or more LED lights, an LCD screen, a speaker, a buzzer, etc.). It may comprise an on/off switch (not shown) or on/off button (not shown). One example of a battery power source is a USB-compatible external battery, which allows a user to charge a small electronic device. Some USB-compatible external batteries require the user to insert disposable batteries into the device. Others utilize a permanently installed rechargeable battery. A battery power source may also comprise a fuel cell (e.g. a butane powered fuel cell).

In one embodiment, shown in FIG. 1, power source 16 comprises a USB-compatible battery power source mounted to the outer surface of inlet 22 using battery power source holder 38. Battery power source holder 38 should be of a suitable size, shape, capacity, and/or adjustability to accommodate a suitably wide range of battery power source sizes and shapes. In one embodiment, shown in FIG. 1-2, battery power source holder 38 comprises a pair of adjustable straps. Adjustment of a strap-type battery power source holder 38 may be accomplished by any suitable means, such as a hook and loop fastener, any type of friction buckle, a magnetic fastener, etc. In one embodiment, battery power source holder straps 38 are replaced by a metal, nylon, or cloth-like mesh drawstring bag, bin, or container.

The placement of battery power source holder 38 and the battery power source of power source 16 in FIG. 1-2 is exemplary, and it will be appreciated that battery power source holder 38 and/or power source 16 may be mounted at any other suitable location on duct 12 and that the components of power source 16 may be mounted at separate suitable locations. However, in some embodiments the mounting location promotes cooling of power source 16. This cooling occurs due to enhanced convection (faster moving air) and/or due to the lower air temperature resulting from the pressure drop in the surrounding air just before it reaches fan 14. This cooling effect may help to promote longevity in certain batteries, such as lithium-ion batteries. It should be noted that battery power source holder 38 is designed to leave a sufficiently large gap between the battery power source of power source 16 and the opening of inlet portion 22 of duct 12, in order to prevent substantial blockage of air flow into duct 12.

Power source 16 may be included with ventilation system 10, or it may be obtained separately by the user. In one embodiment, shown in FIG. 1-2, power source 16 is electrically connected to ventilation system 10 using a suitable electrical connector 40. Power source 16 may comprise one or more of the following: a lithium-ion battery power source, a nickel-cadmium battery power source, a lithium-ion polymer battery power source, an alkaline battery power source, or any other type of suitable battery power source or battery power source pack. Power source 16 may be permanently fixed to duct 12, or it may be removable. In one embodiment, power source 16 further comprises an electric input socket 41 (shown unobstructed in FIG. 6) of any suitable type (e.g. micro USB) to charge the battery power source 16. In one embodiment (not shown), ventilation system 10 further comprises an electric input socket (not shown) accessible from the outside of duct 12 of any suitable type (e.g. micro USB) to supply electric current from power source 16 to fan 14 and/or other electrical components.

In one embodiment, power source 16 comprises an electronic battery power source management system (not shown), which may be capable of charging, discharging, preventing overcharging, preventing over discharging, preventing thermal runaway, preventing overheating, preventing short circuiting, releasing internal battery power source pressure, monitoring the charge state of the battery power source, and even communicating the charge state to the user using any suitable known means (one or more LED lights, LCD display, etc.). Power source 16 may comprise an on/off switch (not shown) or button (not shown). In one embodiment, shown in FIG. 1-2, electrical connector 40 is a USB connector, but any sufficiently small electrical connector may be used. In one embodiment, electrical connector 40 is inserted into an electric output socket 43 (shown unobstructed in FIG. 6) on power source 16 on one end and attached to a wire 42 on an opposing end. The other end of wire 42 may be terminated with a similar electrical connector (not shown), such as a micro USB connector for insertion into a female micro USB port (not shown) on duct 12, or it may be hard-wired either to a suitable electric circuit (not shown) or directly to fan 14.

In one embodiment, power source 16 comprises a solar panel (not shown). The solar panel may be mounted to duct 12 inside the motor vehicle such that it faces the sunlight entering the window. Alternatively, the solar panel may be mounted to duct 12 outside of the motor vehicle on an adjustable locking hinge such that the user may face the panel into direct sunlight. The solar panel may be directly wired to fan 14, or it may charge a battery power source and/or a capacitor, which may store electrical energy for later use.

In one embodiment, fan 14 is wired to a timer (not shown) which allows the user to set an amount of time to delay the activation of fan 14 once it has been plugged in and/or activated. The timer should be capable of being set to a suitable range of times starting at zero and employing either discrete or continuous settings. In one embodiment, the timer allows for daily and/or weekly schedules to be set. The timer may employ any suitable interface, such as a digital liquid crystal display and one or more buttons or a simple dial 44 (as shown in FIG. 1-2). The placement of dial 44 on the lower right hand side of middle portion 24 of duct 12 is exemplary, and it will be appreciated that dial 44 may be located at any suitable location on duct 12; preferably it remains inside the motor vehicle once duct 12 is installed.

The timer may employ any known and suitable electric, mechanical, or electromechanical means to delay the activation of fan 14. In one embodiment, an on/off switch (not shown) allows the user to active the fan and/or to reset the timer. This switch may be a push button (toggle or temporary) or a rocker-type switch. In some embodiments, where power source 16 is a USB compatible external battery power source and the timer is digital, the timer automatically resets when the battery power source is turned off or unplugged by virtue of the timers' circuit design.

In some embodiments, where power source 16 is a battery power source, a thermal management system may be employed. This will only be necessary if the fan/battery power source combo may present the possibility of overheating the battery power source. The thermal management system may simply represent the strategic placement of the battery power source in the path of the air flow created by fan 14. Additionally or alternatively, the thermal management system may employ a temperature-activated switch (not shown) and/or thermal fuse (not shown), placed within suitable proximity to the battery power source, which automatically switches fan 14 off while the temperature of the switch remains above a safe level. This prevents further internal heat generation within the battery power source. Additionally or alternatively, the thermal management system may employ an electric fuse or circuit breaker, which may deactivate fan 14 if the electric current it draws, exceeds a suitable amount.

### Alternative Embodiments

### FIG. 4 and FIG. 5

In one embodiment, ventilation system 10 comprises an air duct 12, an electric fan 14, and an electric power source 16, and a thermostat (not shown). Motor vehicle window 18 and motor vehicle door 20 are shown for reference purposes.

In one embodiment, the inlet 22 of duct 12 is facing upwards such that air is being pulled from the top of the vehicle's interior, where the air is the hottest. In one embodiment, duct 12 comprises rain blocker 29. In one embodiment, rain blocker 29 comprises rain hood 48 as well as a rain plate 50. Rain hood 48 prevents rain from entering outlet 26 of duct 12, while still allowing air to leave duct 12 freely. Rain plate 50 extends substantially vertically from the upper surface of duct 12 near outlet 26. Rain plate 50 is suitably long such that it prevents rain from entering any gap between the top of window 18 and the top of duct 12. Rain plate 50 may be unitarily molded to duct 12 or attached using any type of glue and/or mechanical fasteners (not shown). Rain plate 50 and/or rain hood 48 may be of the same material as duct 12, a rigid material, or a flexible material, such as any type of rubber. In one embodiment, rain plate 50 is made of EPDM foam rubber, but is may also be made of solid rubber, metal, or plastic. In one embodiment, the air flow path of duct 12 widens laterally and tapers vertically towards outlet 26 so that the pressure difference across the fan blades is reduced while allowing the gap between the window and the door to remain sufficiently small. In one embodiment, duct 12 has been designed with substantially flat walls to facilitate the manufacture of duct 12.

In one embodiment, a sealing lid (not shown) is rotatably or slidably mounted duct 12 near outlet portion 26 in order to temporarily substantially seal the opening of outlet 26 during driving. The lid may remain open while the car is parked, but when the car is moving, system 10 may employ any suitable mechanical or electromechanical means to move the lid in order to substantially seal the interior of the vehicle. In one embodiment, the lid is opened and closed manually by the user. In one embodiment, the geometry of the lid is such that the high-speed air moving over the lid while driving creates natural pressure forces that close the lid. A linear or rotary damper (not shown) may be employed to keep the lid from being damaged or making a loud noise when closing. In one embodiment, an electrical sensor (not shown) detects when the car is moving (by measuring wind speed, noise level caused by turbulent wind, etc.), and relays the signal to an appropriately designed circuit (not shown), which in turn sends a signal to an electric motor (not shown), which automatically closes the lid. A built in timer (not shown) may allow the lid to remain closed for a suitable amount of time (longer than the average red traffic signal but shorter than the time for a car to heat up a substantial amount when parked in the sun), so that the lid does not open and close frequently during regular driving, while still remaining open during the ventilation process.

In one embodiment, battery power source holder 38 comprises a pocket, which is unitarily molded to duct 12. Connector 40 has been left out of FIG. 6 so that battery power source 16 can be seen easily, but it should be assumed that it will be connected to battery power source 16 during normal operation of ventilation system 10.

In one embodiment, battery power source 16 is connected electrically to the thermostat (not shown). The thermostat may employ any electric, mechanical, or electromechanical means to control the amount of electric power supplied to fan 14. In one embodiment, the thermostat has two threshold temperatures, such that the fan turns on at the greater of the two, and turns off at the lesser of the two. In another embodiment, the thermostat has only one threshold temperature such that the fan turns on above the threshold, and turns off below the threshold. In another embodiment, the thermostat varies the fan speed based on temperature. The thermostat allows battery power to be conserved when the interior temperature of the car is not too hot, while allowing optimal airflow to be achieved when the temperature inside the car increases a substantial amount.

In one embodiment, where power source 16 is a USB compatible external battery power source and a timer and or a thermostat is employed, a small amount of electric current is drained from the battery power source using a suitably chosen resistor (not shown) in order to keep the battery power source active while the timer and/or thermostat is running. This is necessary as many USB compatible external batteries require a minimum current requirement to remain active. Thus, once the timer runs out or the car temperature rises above the thermostat's threshold, the battery power source will be switched from supplying electric current to the resistor to supplying electric current to fan 14.

In one embodiment, a battery indicator (not shown) may be included to let the user know how much energy remains in battery power source 16. In one embodiment, the battery indicator comprises one or more LED lights which turn on and off based on the amount of energy left in battery power source 16. Additionally or alternatively, the battery indicator may comprise an audio component to alert the user of a low battery through the use of an audio signal.

### Operation

### FIG. 1-3

In one embodiment, shown in FIG. 1-3, the user secures USB-compatible battery power source 16 to duct 12 using battery power source holder straps 38 and plugs in electrical connector 40. The user then sets the amount of time that he or she would like to delay the activation of fan 14 and turns on power source 16 (if necessary). The user then affixes one or more pieces of properly trimmed weather stripping 32 to the upper edge of window 18. Next, the user places overhang 27 of duct 12 over the upper edge of window 18 and then closes the window onto duct 12.

To remove the device, the user simply grasps the device and rolls down window 18 a sufficient amount. The user then removes the device from window 18 and unplugs and/or turns off power source 16. The user then may remove the weather stripping from the window and remove power source 16 from duct 12 by unfastening battery power source holder straps 38.

### Operation

### Alternative Embodiments

### FIG. 4-7

In one embodiment, shown in FIG. 4-7, the user places USB-compatible battery power source 16 into battery power source holder pocket 38 of duct 12. The user then connects electrical connector 40 to battery power source 16. The user then affixes one or more pieces of properly trimmed weather stripping 32 to the upper edge of window 18. Next, the user places overhang 27 of duct 12 over the upper edge of window 18 and then closes window 18 onto duct 12. No electrical switch or timer is necessary, as the thermostat automatically turns on fan 14 whenever the vehicle's interior temperature increases above a suitable threshold. However, an electrical switch and/or a timer may exist in addition to the thermostat.

To remove the device, the user simply grasps the device and rolls down window 18 a sufficient amount. The user then removes the device from window 18 and unplugs and/or turns off power source 16. The user then may remove the weather stripping from the window and remove power source 16 from battery power source holder pocket 38 of duct 12.

### Operation

### Other Embodiments

In one embodiment, ventilation system 10 is identical to the one shown in FIG. 1-3, except that no timer is included. Using this system, the user secures power source 16 (e.g. a USB-compatible battery power source or battery power source pack) to duct 12 using battery power source holder straps 38 and plugs in electrical connector 40. In one embodiment, the user then affixes one or more pieces of properly trimmed weather stripping 32 to the upper edge of window 18. Next, the user places overhang 27 of duct 12 over the upper edge of window 18 and then closes window 18 onto duct 12.

To remove the device, the user simply grasps the device and rolls down window 18 a sufficient amount. The user then removes the device from window 18 and unplugs and/or turns off power source 16. In one embodiment, the user then may remove the weather stripping from window 18. The user then may remove power source 16 from duct 12 by unfastening battery power source holder straps 38.

I claim:

1. A window-mounted motor vehicle ventilation system, comprising:
a duct which may be removably mounted in a gap between a motor vehicle's window and the surrounding door frame;
a fan attached to the duct to exchange fluid between the interior of the motor vehicle and its surroundings; and
a power source comprising a battery to provide power to the fan.

2. The system of claim 1 further comprising: one or more pieces of weather stripping installed adjacent to the duct in the gap to prevent unwanted substances (e.g. precipitation, pollen, dust, gasses, and the like) from entering the vehicle.

3. The system of claim 1 further comprising: an opening on the wall of the duct which is substantially parallel to the window and a gasket located around the periphery of the opening to seal the duct to the window, thereby allowing the duct to use the window as one of its walls.

4. The system of claim 1 further comprising: a thermostat that controls the fan to regulate the air temperature inside the vehicle.

5. The power source of claim 1 further comprising: a solar panel, which may be used to directly power the fan and/or to charge the battery.

6. The system of claim 1 further comprising: a timer, which may be set to delay the operation of the fan and/or to synchronize the operation of the fan with a programmed schedule.

7. The system of claim 1 further comprising: a rain blocker to prevent rainwater from entering the vehicle through the outlet of the duct and/or through small gaps between the duct and the door frame.

8. The system of claim 1 further comprising: a means (e.g. a sealing lid) of sealing an opening in the duct while the vehicle is being driven.

9. The system of claim 1 further comprising: a means of indicating the level of charge of the battery to a user.

10. The system of claim 1 further comprising: a means of preventing incidental contact between a user and the fan's blades.

11. The duct of claim 1 further comprising: an overhang, which prevents the duct from slipping out of the window in which it is mounted.

12. The duct of claim 1 further comprising: contact pads mounted to the duct at the locations where the duct contacts the window to prevent damage to the window or to any existing window mounted products such as coatings, tints, decals, and the like.

13. The power source of claim 1 further comprising: an electronic battery power source management system, which may be capable of charging, discharging, preventing overcharging, preventing over discharging, preventing thermal runaway, preventing overheating, preventing short circuiting, releasing internal battery pressure, and/or monitoring the charge state of the battery power source.

14. The power source of claim 1 further comprising: an on/off switch.

15. The power source of claim 1 wherein the power source is removable.

16. The power source of claim 1 wherein the power source is not removable.

17. The power source of claim 1 further comprising: an electric input socket employing USB technology

18. The power source of claim 1 further comprising: an electric output socket employing USB technology

19. The duct of claim 1 wherein the air flow path of the duct widens laterally along the length of the gap while tapering vertically along the width of the gap as from the duct's inlet towards its outlet so that the pressure difference across the fan blades is reduced while allowing the gap between the window and the door to remain sufficiently small.

20. A method for ventilating a motor vehicle, comprising:
a method for exchanging fluid between the interior of the motor vehicle and its surroundings; and
a method for storing energy in a USB-compatible form.
